(19) United States
(12) Patent Application Publication
(10) Pub. No.: US 2002/0167808 A1
(43) Pub. Date: Nov. 14, 2002

(54) Garlanded lighting string

(76) Inventor: Wun-Whe Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/850,086

(22) Filed: May 8, 2001

(51) Int. Cl. F21S 13/14

(52) U.S. Cl. 362/252; 362/122; 362/806

(57) ABSTRACT

The present invention relates to a garlanded lighting string, which includes a straight electrical wire being connected with several bulb assemblies as a group and irregularly extended outward. Each group of the bulb assembly is conductively connected with the electrical wire at interval. So the garlanded lighting string can provided a better lighting effect and improves the decorative purpose without any affiliated reflection.

### BACKGROUND OF THE INVENTION

A conventional straight lighting string includes a main straight electrical wire, which is provided with a bulb assembly at interval for lighting purpose. Since there is one single bulb provided at interval, it could not provide enough lighting degree in use. It is known to use some reflective slices winded around the string for increasing the lighting but the effect is not proved.

Accordingly, the primary object of the invention is to provide a garlanded lighting string, which connects with several bulb assemblies around the electrical wire as a group to provide a better decorative effect. Now the features and advantages of the present invention will be described in detail with reference to the accompanying drawings.

### BRIEF DESCRIPTION OF ACCOMPANYING DRAWINGS

FIG. 1 is a perspective view showing a part of a garlanded lighting string according to the present invention.

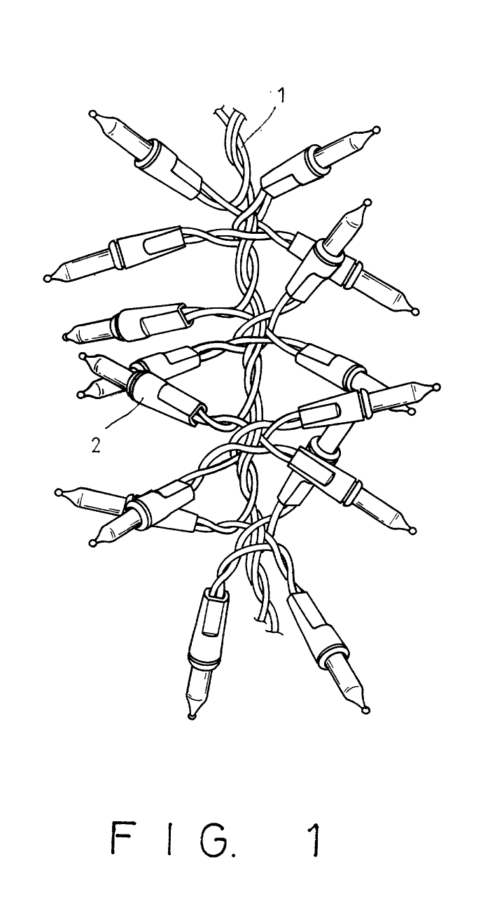

### DETAILED DESCRIPTION OF PREFERRED EMBODIMENTS

Referring to the attached figure, the present invention is an improvement of a straight lighting string, which includes a straight wire (1). Several bulb assemblies (2) being a group, are conductively connected with the main wire (1) and extended outward irregularly. Each group is then connected with the wire (1) at suitable interval. In this drawing, there are four bulb assemblies being only an exemplary embodiment and being capable of change.

As the above mention, it can be found that the use of the present invention can provide multiple lighting spots and better lighting effect without other reflective paper. The whole string becomes a garland, which obtains a perfect decorative effect and beauty and is better than every prior straight string.

Accordingly, the present invention obviously gains the utility and novelty for patent and is thus applied.

What is claimed is:

1. A garlanded lighting string being a straight string, which includes a main electrical wire being connected with several bulb assemblies as a group at suitable interval and each bulb assembly being extended outward irregularly.
